(19) United States
(12) Patent Application Publication
(10) Pub. No.: US 2002/0168011 A1
(43) Pub. Date: Nov. 14, 2002

(54) Method of detecting noise in a coded video data flow

(76) Inventor: Arnaud Bourge, Paris (FR)

Correspondence Address: U.S. Philips Corporation, 580 White Plains Road, Tarrytown, NY, 10591, US

(21) Appl. No.: 10/127,529

(22) Filed: Apr. 22, 2002

(30) Foreign Application Priority Data
Apr. 24, 2001 (FR) 0105507

(51) Int. Cl. H04N 7/12

(52) U.S. Cl. 375/240.27

(57) ABSTRACT

The present invention relates to a method of detecting noise in a flow of video data coded by macroblocks according to a predictive block-based encoding technique, the macroblocks being coded according to a coding type. Said method comprises a step of reading the coded video data flow in order to detect, in a current image, an intra coding type and a position of a macroblock corresponding to this coding type, hereinafter referred to as intra macroblock. It also comprises a step of seeking the coding type or types of a set of reference macroblocks in a reference table containing the coding types of macroblocks contained in a reference predictive-coded image, all the reference macroblocks having, in the reference image, a position close to the position of the intra macroblock in the current image. Finally, it comprises a step of detecting a noisy macroblock from the coding type or types of all the reference macroblocks.

The present invention relates to a method of detecting noise in a flow of video data coded by macroblocks according to a predictive block-based encoding technique, the macroblocks being coded according to a coding type.

The invention relates to a method of reducing noise in such a video data flow.

The invention also relates to a transcoding method using such noise detection and reduction methods.

Finally, the invention relates to a computer program product for implementing the noise detection method, the noise reduction method and the transcoding method.

The invention finds its application in particular in the transcoding of video data, of the MPEG type for example, for a high-quality recording of said video data when they are transcoded at a variable rate.

European patent application N° 1 032 217 discloses a method and a device for transcoding coded digital video data including a noise reducer. Such a method of transcoding (10) coded digital video data comprises in series:

a step of decoding (100) the coded video data flow able to supply a flow of reconstructed intermediate data, said decoding step comprising the substep of variable length decoding VLD (101), inverse quantization IQ (102) and inverse discrete cosine transformation IDCT (103), as well as a first motion compensation (104, 105, 106),

an intermediate step of processing (110) the reconstructed intermediate data flow, including notably a noise reduction filter DF (111), for supplying a flow of modified reconstructed intermediate data, and

a step of coding (120) the modified reconstructed intermediate data flow, able to supply a modified coded video data flow, said coding step comprising the substeps of discrete cosine transformation DCT (122), quantization Q (123), variable length coding VLC (124), as well as a second motion compensation (121, 125, 126, 127, 128, 129).

The noise reduction step is performed in the spatial domain using reconstructed data. Thus it is not applicable to a transcoder which comprises a partial decoding step, that is to say without a substep of inverse discrete cosine transformation IDCT (103) as described in European patent N°0 690 392, and which because of this does not reconvert the coded video data in the spatial domain. In addition, the method of transcoding coded digital video data also does not include the noise detection step strictly speaking, on the basis of which the noise reduction step could be applied more effectively.

The object of the present invention is to propose a noise detection method which can be implemented in a simple and effective fashion without decoding and reconstruction of the data in the spatial domain.

To this end, the noise detection method as described in the opening paragraph is characterized in that it comprises the steps of:

reading the coded video data flow in order to detect, in a current image, a type of intra coding and a position of a macroblock corresponding to this coding type, hereinafter referred to as an intra macroblock,

seeking the coding type or types of a set of reference macroblocks in a reference table containing the macroblock coding types contained in a reference predictive-coded image, the set of reference macroblocks having, in the reference image, a position close to the position of the intra macroblock in the current image, and

detecting a noisy macroblock using the coding type or types of the est of reference macroblocks.

Such a method is able to detect a noisy zone using simply the coding type of the macroblocks of any current image, in this case the intra coding type, as well as the coding types of the macroblocks of a reference image which is a bidirectionally predictive-coded B image or preferably a predictive-coded P image. It thus uses data directly accessible from the coded video data flow, for example issuing from a variable length decoding step VLD. This method is therefore particularly simple since it does not require a complicated statistical analysis of the video data flow, does not have recourse to future data, and does not require inverse transformation, of the IDCT type for example, of the data macroblocks since it is effected directly from coding types of the images and macroblocks.

Another object of the present invention is to propose a noise reduction method in a coded video data flow, which can be implemented in the frequency domain. To this end, such a noise reduction method comprises a noise detection step as described previously, which is able to supply, for a current macroblock, a noise level from the video data flow, and also comprises a spatial filtering step able to supply a filtered data macroblock according to the noise level supplied by the detection step.

Thus the noise reduction method no longer requires, contrary to the prior art, passing into the spatial domain again in order to carry out a filtering of the noisy data, the filtering being directly applied in the frequency domain on coded data macroblocks.

Finally, the object of the present invention is to propose a method of transcoding a first coded video data flow into a second coded video data flow, which improves the quality of the second coded video data flow.

To this end, the transcoding method comprises a step of decoding a current macroblock included in the first coded video data flow, said decoding step comprising a variable length decoding substep and an inverse quantization substep, and a coding step, following the decoding step, able to supply the second coded video data flow, said coding step comprising a quantization substep, and is also remarkable in that it comprises the steps of:

noise detection, able to supply for the current macroblock a noise level from coding types of the current macroblock and a set of reference macroblocks issuing from the variable length decoding substep, and

spatial filtering between the inverse quantization substep and the quantization substep, the transcoding method being able to apply or not the filtering step to the current macroblock according to the noise level supplied by the noise detection step.

Such a transcoding method makes it possible to detect the noisy macroblocks and to apply to them a filtering adapted to the value supplied by the noise detection step. It thus makes it possible to effect an adaptive filtering which improves the quality of the transcoded images. The simplicity of the noise detection step, the low memory resources which it uses and the fact that it operates on a flow of non-decoded data make the transcoding method particularly effective.

The invention will be further described with reference to examples of embodiments shown in the drawings to which, however, the invention is not restricted.

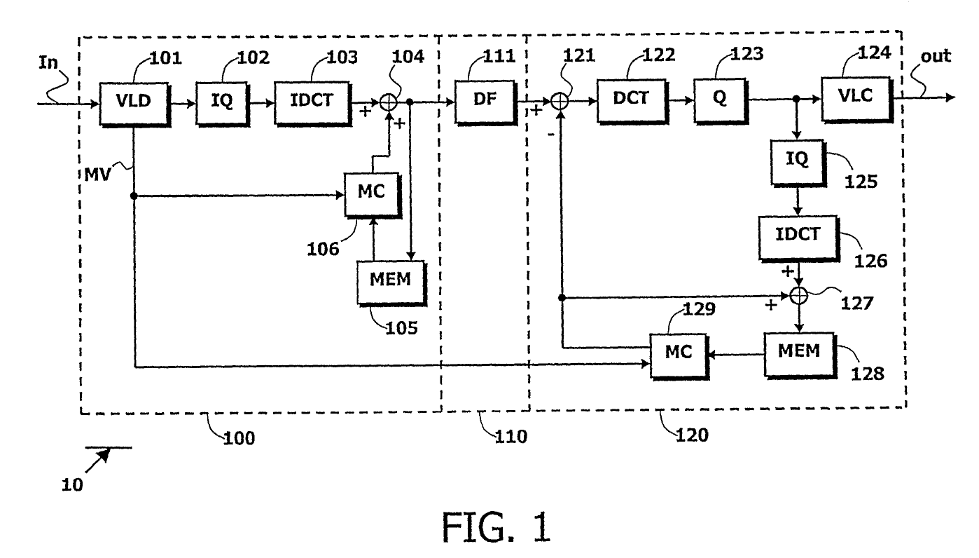

FIG. 1 is a schematic representation of a transcoding method according to the state of the prior art,

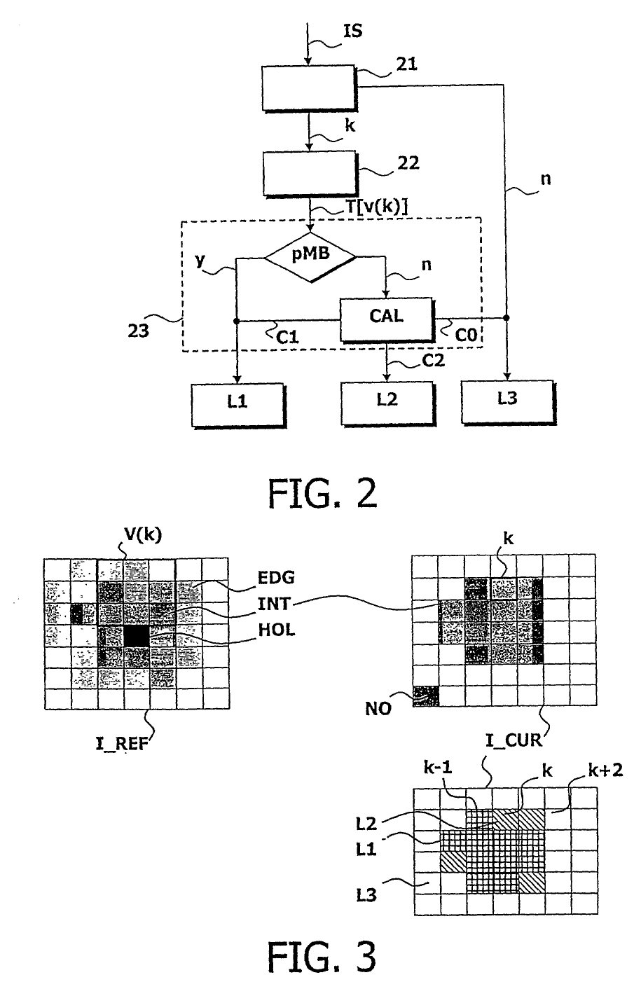

FIG. 2 is a diagram depicting the main steps of the noise detection method according to the invention,

FIG. 3 is an example of a result of the noise detection method, and

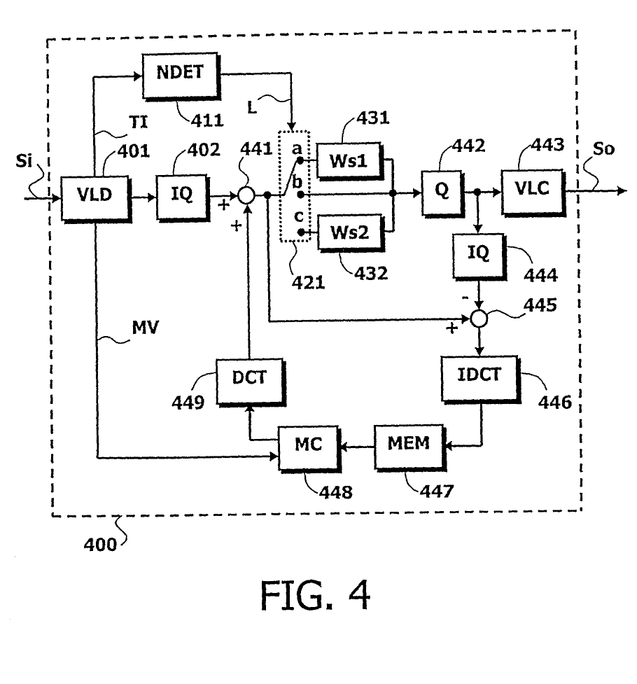

FIG. 4 is a schematic representation of a transcoding method according to the invention and of the transcoder corresponding to it.

The present invention relates to a method of detecting noise in a flow of video data coded by macroblocks according to a block-based encoding technique. Said coding technique effects a predictive coding by coding the macroblocks according to a coding type, the intra type when the macroblock is coded without reference to a macroblock of a previous image, the inter type when the macroblock is coded with reference to a macroblock of a previous image. The block-based encoding technique is, for example, the MPEG standard which decomposes the images into blocks of 8 lines of 8 pixels, a macroblock generally comprising, i.e. in the case of a 4:2:2 format, four luminance blocks Y, one chrominance block U and one chrominance block V.

The present invention takes advantage of the observation that a macroblock which contains noise has a high probability of being coded according to the intra type even when it belongs to a P image with predictive coding or to a B image with bidirectionally predictive-coded. Such a macroblock often belongs to a homogeneous zone, and the motion estimator of a coder is able to predict that a coding of the intra type of the noisy macroblock will correspond to a minimum number of bits transmitted.

However, other reasons may be at the origin of the coding of a macroblock according to the intra type such as, for example, a change in scene or the appearance of a new object within a sequence of images. In addition, the intra coding images I by nature contain only macroblocks of the intra type and it is improbable that all these macroblocks will be noisy macroblocks.

The noise detection method according to the invention takes these various considerations into account. FIG. 2 is a diagram representing the main steps of said noise detection method. This method comprises a step (21) of reading the coded video data flow (IS) in order to detect, in a current image, an intra coding type and a position (k) of a macroblock corresponding to this type of coding, hereinafter referred to as an intra macroblock. This information is contained in the headers of the coded video data flow. If a macroblock of the current image is not of the intra type, then it is not a noisy macroblock (L3).

The noise detection method also comprises a step (22) of seeking the coding type or types (T[v(k)]) of a set of reference macroblocks in a reference table (T) containing the macroblock coding types contained in a reference predictive-coded image, the set of reference macroblocks having, in the reference image, a position (v(k)) close to the position of the intra macroblock in the current image. The reference image is a bidirectionally predictive-coded B image, or preferably a predictive-coded P image since this type of image holds more macroblocks of the intra type than a B image, and consequently provides better effectiveness of the noise detection method. The position k varies from 1 to N, that is to say, in a standard-format image (720×576 pixels), from 1 to 1620 and corresponds to coordinates (k,l) of the macroblock in the image. The reference table is therefore preferably a table of 1620 binary values, initialized for example with 0, a ‘0’ corresponding to a macroblock of the inter type while a ‘1’ corresponds to a macroblock of the intra type.

Finally, the noise detection method comprises a step (23) of detecting a noisy macroblock from the coding type or types of the set of reference macroblocks.

In a particularly advantageous embodiment, the set of reference macroblocks consists of a single macroblock of position k in the reference image. Thus, if a macroblock of position k is of the intra type in the current image and in the reference image, the macroblock of the current image is a noisy macroblock.

In the preferred embodiment, the detection step also comprises a substep (CAL) of calculating an environment value (C) from a number of intra coding types of the set of reference macroblocks. In this case, the set of reference macroblocks consists of a macroblock of position k in the reference image and the 8 macroblocks which are contiguous with it. It will be clear to a person skilled in the art that this set may be restricted or on the contrary extended according to the memory resources available and the precision of the method which it is wished to obtain. A test substep (pMB) on the coding type of a macroblock of position k in the reference image is carried out prior to the calculation substep. If a position macroblock k is of the intra type in the current image and in the reference image (y), then the macroblock of the current image is a main noisy macroblock (L1). If a macroblock of position k is an intra macroblock in the current image but not in the reference image (n), then the environment value is taken into consideration. If the environment value (C1) is greater than or equal to a first threshold, 6 for example, that is to say if 6 of the 8 contiguous macroblocks are macroblocks of the intra type, then the macroblock of the current image is a main noisy macroblock (L1). If the environment value (C2) is greater than or equal to a second threshold, 1 for example, and less than the first threshold, then the macroblock of the current image is a border noisy macroblock (L2). Finally, if the environment value (C0) is less than the second threshold, the macroblock of the current image is not a noisy macroblock (L3).

Such a noise detection method is advantageously used, for example, for estimating, in a simple and rapid fashion, a quantity of noise in an image, and can thus be a component of a quality measurement in a sequence of images. In the preferred embodiment, said method is used for effecting a noise reduction in an adaptive fashion.

This is because the detection step is able to allocate two noise levels (L1, L2) for a macroblock, a principal level and a level corresponding to a noisy zone boundary, from the environment value. The processing of the noisy macroblocks thus detected can thus be adapted according to the noise level. This processing is, in the preferred embodiment, a spatial filter Ws, defined for each coefficient of the frequency domain of position (i,j) in a luminance or chrominance block of the noisy macroblock, as follows:

$${Ws}_{i , j} = \frac{2 cos ( iπ / 8 ) + {a}_{v}}{2 + {a}_{v}} \cdot \frac{2 cos ( jπ / 8 ) + {a}_{h}}{2 + {a}_{h}} .$$

If the current macroblock is not a noisy macroblock (L3), no spatial filtering is carried out. On the other hand, if the current macroblock is a main noisy macroblock (L1), a moderate filtering is carried out, with aₕ=aᵥ=8 for example. Finally, if the current macroblock is a boundary noisy macroblock (L1), a light filtering is carried out with aₕ=aᵥ=16 for example. In this way a particularly effective noise reduction method is obtained because of this adaptive filtering. Such a method can advantageously be used in a video coder for reducing the noise in the image during coding, or in a decoder for reducing the noise in the image during decoding.

FIG. 3 is an example of a result of the noise detection method according to the invention. The macroblocks of the intra type (INT) are shown in dark gray in the reference image (I_REF) and in the current image (I_CUR). In addition the contiguous macroblocks (EDG) of the inter type contained in the reference image and to be taken into consideration for each intra macroblock of the current image are depicted in light gray. An inter macroblock, hereinafter called a hole macroblock (HOL), surrounded by intra macroblocks, is also depicted in black in the reference image. For a macroblock of position k, the set of reference macroblocks (v(k)) is depicted. The following principal results are obtained.

The macroblock of position (k−1) is of the intra type for the current and reference images. This is therefore a main noisy macroblock (L1), represented by a grid.

The hole macroblock in the reference image is a macroblock of the intra type in the current image. Its environment value being 7, this is therefore also a main noisy macroblock (L1).

The macroblock of position k is a macroblock of the intra type in the current image but not in the reference image. Its environment value being 4, this is a boundary noisy macroblock (L2) depicted here by diagonal hatching.

The macroblock of position (k+2) is not a macroblock of the intra type in the current image, and it is therefore not a noisy macroblock (L3).

The macroblock corresponding to a new object (NO) in the current image is of the intra type in said image but has a zero environment value. This is therefore also not a noisy macroblock (L3).

FIG. 4 is a schematic representation of a transcoding method (400) according to the invention. Said transcoding method converts a first flow of video data (Si) coded by macroblocks according to a block predictive coding technique, into a second flow of coded video data (So).

For this purpose, it comprises a step of decoding a current macroblock included in the first coded video data flow, said decoding step comprising a substep of variable length decoding VLD (401) followed by a first inverse quantization IQ substep (402).

The transcoding method comprises a coding step able to supply the second coded video data flow, said coding step comprising a quantization substep Q (422) followed by a variable length coding VLC substep (443). It also includes a prediction step comprising in series the substeps of second inverse quantization IQ (444), subtraction (445), inverse discrete cosine transformation IDCT (446), image storage MEM (447), motion compensation MC (448), discrete cosine transformation DCT (449) and addition (441). The addition substep is able to effect the sum of a block of motion-compensated transform data issuing from the DCT transformation and a block issuing from the first inverse quantization substep IQ (402). The second inverse quantization substep IQ (444) is able to quantize a block issuing from the quantization substep Q. The subtraction substep is able to obtain the difference between a block issuing from the addition substep and a block issuing from the second inverse quantization substep IQ (444). The motion compensation substep MC is able to supply a block of motion-compensated reconstructed data from a motion vector (MV) supplied by the variable length decoding substep VLD and the content of the image memory MEM.

The transcoding method also comprises a noise detection step NDET (411) as described in FIG. 2 and which supplies, for a current macroblock, a noise level (L) from information issuing from the variable length decoding step VLD concerning the coding type of the macroblocks (TI). It also comprises a spatial filtering step Ws (431, 432) situated between the first inverse quantization substep IQ (402) and the quantization substep Q (442). The noise detection step controls a switching step (421) from the noise level (L) associated with a current macroblock.

In a particularly advantageous embodiment, if the current macroblock is a noisy macroblock, then the filtering step applies a spatial filter Ws as described above. On the other hand, if the current macroblock is not a noisy macroblock, the filtering step is inhibited.

In the preferred embodiment, the current macroblock may be allocated two noise levels:

if the current macroblock is a main noisy macroblock (L1), then the filtering step applies a spatial filter Ws1 (431) to the blocks of the current macroblock, with aₕ=aᵥ=8 for example, corresponding to a first position (a) of the switching step,

if the current macroblock is a boundary noisy macroblock (L2), then the filtering step applies a spatial filter Ws2 (432) to the blocks of the current macroblock, with aₕ=aᵥ=16 for example, corresponding to a second position (c) of the switching step.

Finally, if the current macroblock is not a noisy macroblock (L3), the filtering step is inhibited, corresponding to a third position (b) of the switching step.

A transcoding method including such a noise reduction thus improves the quality of the transcoded images, notably when the noise is fairly great. The transcoding can moreover be improved still further when the macroblocks of the inter type of the current image which are not spatially filtered by the filtering step (431, 432) are filtered temporally.

The present invention can be implemented in the form of software loaded on one or more circuits implementing the noise detection, noise reduction or transcoding method previously described. There are many ways of implementing the functions described above by means of software. In this regard, FIGS. 2 and 4 are highly schematic. Therefore, although a figure shows various functions in the form of separate blocks, this does not exclude a single software package performing several functions. Nor does this exclude the fact that a function can be performed by a set of software packages. It is also possible to implement these functions by means of a noise detection circuit, a noise reduction circuit or a transcoding circuit, said circuit being suitably programmed. A set of instructions contained in a programming memory can cause the circuit to perform the various operations described above with reference to FIGS. 2 and 4. The set of instructions can also be loaded into the programming memory by the reading of a data carrier such as for example a disk which contains the set of instructions. The reading can also be carried out by means of a communication network such as for example the Internet. In this case, a service provider will make the set of instructions available to interested parties.

FIG. 4 is also a schematic representation of a transcoder according to the invention, a functional block representing this time a circuit of the transcoder instead of a step of the transcoding circuit. The transcoder comprises notably a noise detection circuit (411) produced, for example, according to the principle which has just been described. The detection circuit is able to supply for a current macroblock a noise level (L) from coding types (TI) of the current macroblock and reference macroblock or blocks issuing from a variable length decoding circuit VLD (401). The transcoder also comprises a spatial filtering unit between an inverse quantization circuit (402) and a quantization circuit (442), the filtering unit itself having a switch (421) intended to select (a, b, c) a filter (431, 432) of the filtering unit in order to apply it to the current macroblock. The noise detection circuit controls the switch from the noise level so as to apply or not a filter according to the principle which was previously described.

No reference sign between parentheses in the present text should be interpreted limitatively. The verb “comprise” and its conjugations does not exclude the presence of elements or steps other than those listed in a sentence. The word “a” or “one” preceding an element or step does not exclude the presence of a plurality of such elements or steps.

1. A method of detecting noise in a flow of video data (IS) coded by macroblocks according to a predictive block-based encoding technique, the macroblocks being coded according to a coding type, said method comprising the steps of:
reading (21) the coded video data flow in order to detect, in a current image (I_CUR), a type of intra coding and a position (k) of a macroblock corresponding to this coding type, hereinafter referred to as an intra macroblock,
seeking (22) the coding type or types (T[v(k)]) of a set of reference macroblocks in a reference table (T) containing the macroblock coding types contained in a reference predictive-coded image (I_REF), the set of reference macroblocks having, in the reference image, a position (v(k)) close to the position of the intra macroblock in the current image, and
detecting (23) a noisy macroblock using the coding type or types of the set of reference macroblocks.

2. A noise detection method as claimed in claim 1, wherein the detection step also comprises a substep of calculating (CAL) an environment value (C) from a number of intra coding types of the set of reference macroblocks, the detection step being able to allocate to a macroblock at least two noise levels (L1, L2) from the environment value.

3. A method of reducing noise in a flow of video data (IS) coded by macroblocks according to a predictive block-based encoding technique, the macroblocks being coded according to a coding type, said method comprising the steps of:
detecting noise as claimed in claim 1 or 2, able to supply, for a current macroblock, a noise level (L) from the video data flow, and
spatial filtering able to supply a filtered data macroblock according to the noise level supplied by the detection step.

4. A method of transcoding a first flow of video data (Si) coded by macroblocks according to a predictive block-based encoding technique, into a second flow of coded video data (So), said transcoding method comprising the steps of:
decoding a current macroblock included in the first coded video data flow, said decoding step comprising a variable-length decoding substep (401) and an inverse quantization substep (402),
coding, following the decoding step, able to supply the second coded video data flow, said coding step comprising a quantization substep (442), characterized in that the transcoding method also comprises the steps of:
noise detection (411), able to supply, for the current macroblock, a noise level (L) from coding types (TI) of the current macroblock and a set of reference macroblocks issuing from the variable-length decoding substep, and
spatial filtering (431, 432) between the inverse quantization substep and the quantization substep, the transcoding method being able to apply or not the filtering step to the current macroblock according to the noise level supplied by the noise detection step.

5. A device for transcoding a first flow of video data (Si) coded by macroblocks according to a predictive block-based encoding technique, into a second coded video data flow (So), said transcoding device comprising:
a unit for decoding a current macroblock included in the first coded video data flow, said decoding unit comprising a variable-length decoding circuit (401) and an inverse quantization circuit (402),
coding unit, following the decoding unit, able to supply the second coded video data flow, said coding unit comprising a quantization circuit (442), characterized in that the transcoding device also comprises:
noise detection circuit (411), able to supply, for the current macroblock, a noise level (L) from coding types (TI) of the current macroblock and a set of reference macroblocks issuing from the variable-length decoding circuit, and
spatial filtering unit between the inverse quantization circuit and the quantization circuit including a switch (421) intended to select a filter (431, 432) of the filtering unit in order to apply it to the current macroblock, the noise detection circuit being able to control the switch according to the noise level.

6. A “computer program” product for a noise detection device comprising a set of instructions which, when they are loaded in the noise detection device, causes the latter to carry out the noise detection method as claimed in one of claims 1 or 2.

7. A “computer program” product for a noise reduction device comprising a set of instructions which, when they are loaded in the noise reduction device, causes it to carry out the noise reduction method as claimed in claim 3.

8. A “computer program” product for a transcoding device containing a set of instructions which, when they are loaded in the transcoding device, causes the latter to carry out the video data transcoding method as claimed in claim 4.

9. A noise reducer, adapted to receive a flow of video data (IS) coded by macroblocks according to a predictive block-based coding technique, the macroblocks being coded according to a coding type, the noise reducer comprising:
means for detecting noise implementing the method of detecting noise as claimed in claim 1 or 2, and adapted to supply, for a current macroblock, a noise level (L) from the video data flow, and
a spatial filter, adapted to supply a filtered data macroblock according to the noise level.
